(19) United States
(12) Patent Application Publication
(10) Pub. No.: US 2001/0008575 A1
(43) Pub. Date: Jul. 19, 2001

(54) Method and apparatus for searching image of video recording and reproducing device

(76) Inventors: Seung Phil Rho, Pyungtaik (KR); Suk Young Choi, Gangreung (KR)

Correspondence Address: BIRCH, STEWART, KOLASCH & BIRCH, LLP, P.O. Box 747, Falls Church, VA, 22040-0747, US

(21) Appl. No.: 09/764,272

(22) Filed: Jan. 19, 2001

(30) Foreign Application Priority Data
Jan. 19, 2000 (KR) 2453/2000
Jan. 31, 2000 (KR) 4720/2000
Jun. 8, 2000 (KR) 31370/2000

(51) Int. Cl. H04N 5/91; H04N 7/26

(52) U.S. Cl. 386/69; 386/111

(57) ABSTRACT

An apparatus for searching an image of an image recording and reproducing device in which input data streams received from various signal sources are processed and accordingly generated image and audio signals are outputted to an image displayer and a speaker, includes: a data stream selector for receiving the input data streams, selecting and outputting an input data stream of a channel selected by a user; a decoding unit for decoding the data stream outputted from the data stream selector; a formatter for receiving the data stream from the data stream selector, converting it to a record signal, outputting the record signal to a recording medium, detecting the signal recorded in the recording medium, generating a reproduction signal, and outputting the reproduction signal to the data stream selector; a controller for judging whether there is a data stream having an I picture among the input data stream outputted from the data stream selector, a memory associated with the selected input data stream recorded in the recording medium, for storing the data stream having I picture among the selected input data streams under the control of the controller; and a microcomputer for controlling each circuit unit.

### BACKGROUND OF THE INVENTION

1. Field of the Invention

The present invention relates to an apparatus and a method for searching an image of an image recording and reproducing device, and more particularly, to an apparatus and method for searching an image of an image recording and reproducing device in which a randomly accessible large-capacity memory is installed to search an image signal recorded in a digital video tape at a high or low speed.

2. Description of the Background Art

Generally, an image recording and reproducing device such as a VCR records an image signal or an audio signal received from an external source in a video tape or reproduces the image signal or the audio signal recorded in the video tape.

Especially, in case of the digital VCR (a DVHS VCR) which has been recently developed to fit the standard of DVHS and is capable of recording and reproducing a high definition digital image signal, it receives video signals from a various signal sources, digital-signal processes it and records the generated high quality digital image signal in the DVHS tape, and then reproduces the recorded signal from the DVHS tape or outputs the high quality digital image signal to various information processors such as an external editing instrument, a work station or a personal computer, so that the information processors can process the high quality digital image signal.

Since the DVHS-VCR can utilize a high quality information and a large capacity storing medium with the above described function, it is expected to be applied to a variety of technical fields in connection with broadcast satellites, a high definition TV or a set-top box.

The high speed searching operation of the digital VCR (not shown) will now be described.

While the DVHS-VCR is being operated in a normal reproducing mode, in case that a command signal corresponding to a high speed searching command, that is, a cue (forward direction high speed reproducing) or a review (backward direction high speed reproducing), is inputted, the DVHS-VCR repeatedly performs the high speed reproducing mode and the normal reproducing mode at predetermined time intervals and displays the still image reproduced while it is operated at the normal reproducing mode, in the high speed reproducing mode.

In this respect, since the recording format of the DVHS is different from that of an analog VCR, it is not possible to reproduce in the high speed reproducing mode the image signal recorded in the normal recording mode in the video tape.

Thus, the still image reproduced from the video tape in the normal reproducing mode is stored in the output memory.

And then, in the high speed reproducing mode, the still image is displayed on a display unit such as a DTV according to the operation rate of the high speed reproducing mode, so that the user can search his or her desired scene from the video tape or may recognize the story of the content included in the video tape.

However, disadvantageously, the digital VCR displays the still image by repeatedly performing the high speed reproducing operation and the normal reproducing operation for the video tape to perform the high speed reproducing, causing problems that it takes a lot of time to search an image desired by the user, and a complicate servo is necessary for the operation.

In addition, since the operation is repeatedly performed, the durability of of the head and the deck of the digital VCR is shortened.

Meanwhile, as described above, the digital video disk (DVD) records a data and the image recorded in the DVD is randomly accessed to be searched at a high speed.

In this case, even though the complicate servo or a signal processing algorithm is applied to the VCR to randomly access and search at a high speed the image recorded in the digital video tape, a problem still arises that the life span of the head and the deck of the digital VCR is shortened as the digital VCR performs searching at a high speed.

### SUMMARY OF THE INVENTION

Therefore, an object of the present invention is to provide an apparatus and a method for searching an image of an image recording and reproducing device in which a data related to an image signal recorded in and reproduced from a video tape is stored in a large capacity memory and the image signal recorded in the video tape is searched at a high speed or at a low speed.

Another object of the present invention is to provide an apparatus and a method for searching an image of an image recording and reproducing device in which an image signal recorded in a video tape and absolute position information on the video tape where the image signal is recorded are stored in a large capacity memory, so that when a user searches a desired image at a high speed, a still image is outputted.

Still another object of the present invention is to provide an apparatus and a method for searching an image of an image recording and reproducing device in which in case that a user searches an image signal reproduced from a video tape at a low speed, the reproduced image signal is stored in a large capacity memory and then outputted to a display unit such as a DTV at a speed desired by the user.

To achieve these and other advantages and in accordance with the purpose of the present invention, as embodied and broadly described herein, there is provided an apparatus for searching an image of an image recording and reproducing device in which input data streams received from various signal sources are processed and accordingly generated image and audio signals are outputted to an image displayer such as a DTV and a speaker, including: a data stream selector for receiving the input data streams, selecting an input data stream selected by a user and outputting the selected input data stream; a decoding unit for receiving the input data stream outputted from the data stream selector and decoding it to an image signal and an audio signal so as to be displayed on a display unit such as a DTV; a formatter for receiving the input data streams from the data stream selector, and converting it to a record signal, outputting the record signal to a recording medium, detecting the signal recorded in the recording medium, generating a reproduction signal, and outputting the reproduction signal to the data stream selector; a controller for controlling to judge whether there is a data stream having an I picture among the input data streams outputted from the data stream selector, extract the data stream having the I picture from the selected input data streams upon judgement, store it in a memory, read the stored data stream having the I picture from the memory, and output it to the data stream selector; a memory associated with the selected input data stream recorded in the recording medium, for storing the data stream having the I picture among the selected input data streams under the control of the controller; and a microcomputer for controlling each circuit unit.

To achieve the above objects, there is also provided an apparatus for searching an image of an image recording and reproducing device in which input data streams received from various signal sources are processed and accordingly generated image and audio signals are outputted to an image displayer such as a DTV and a speaker, including: a data stream selector for receiving the input data stream, selecting an input data stream of a channel selected by a user and outputting the selected input data stream; a decoding unit for receiving the input data stream from the data stream selector and decoding it to an image signal and an audio signal so as to be displayed on a display unit such as a DTV; a signal processor for receiving the image signal and the audio signal from the decoding unit, encoding and multiplexing them, and outputting the multiplexed data streams and a data stream having an I picture among the multiplexed data stream; a formatter for converting the data stream outputted from the signal processor into a record signal, outputting the record signal to a recording medium, detecting the signal recorded in the recording medium, generating a reproduction signal and outputting the reproduction signal to the decoding unit; a memory for receiving the data stream having an I picture from the signal processor, storing the data stream having the I picture received from the signal processor associated with the data stream recorded in the recording medium, and outputting the stored data stream having an I picture to the decoding unit; and a microcomputer for controlling circuit units

In order to achieve the above objects, there is also provided a method for searching an image of an image recording and reproducing device in which input data streams received from an image and sound signal sources are processed, including a first step in which an input data stream of a channel selected by a user among the input data streams is processed and recorded in a tape, and at the same time, a data stream having I picture among the input data streams of the channel selected by the user is stored in a large capacity memory; a second step in which when the user inputs a backward high speed reproduction command or a forward high speed reproduction command, a still image outputted from the data stream having I picture stored in the memory; and a third step in which when the user inputs a normal reproduction command during the operation in the backward high speed reproducing mode or the forward high speed reproducing mode, the reproducing operation is performed from a position of a tape at which the still image outputted from the memory has been recorded.

In order to achieve the above objects, there is also provided a method for searching an image of an image recording and reproducing device in which input data streams received from an image and sound signal sources are processed, including the steps of: judging whether a DVHS VCR is in a low-speed reproducing mode; operating the tape in a normal reproducing mode and storing the reproduced signal in a memory in case that the DVHS VCR is in the low-speed reproducing mode; and reading the reproduction signal stored in the memory at a low speed and outputting it to a display unit such as a DTV.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of an image searching apparatus of an image recording and reproducing device in accordance with one embodiment of the present invention;

FIG. 2A shows an ES stream;

FIG. 2B shows pictures included in the ES stream of FIG. 2;

FIG. 2C shows packetized elementary stream (PES) of video pictures;

FIG. 2D shows PES of an audio signal;

FIG. 2E shows a transport stream of the PES of the video signal and the audio signal;

FIG. 2F shows a data format recorded in a video tape;

FIG. 3A shows a transport stream recorded in a video tape in accordance with the present invention;

FIG. 3B shows a transport stream recorded in a hard disk in accordance with the present invention;

FIG. 4 is a flow chart of a method for recording an image of an image searching apparatus of an image recording and reproducing device in accordance with the present invention;

FIG. 5 is a flow chart of a high-speed searching method of an image searching apparatus of the image recording and reproducing device in accordance with the present invention;

FIG. 6 is a flow chart of a low-speed searching method of an image searching apparatus of the image recording and reproducing device in accordance with the present invention;

FIG. 7 is a schematic block diagram of an image searching apparatus of an image recording and reproducing device in accordance with another embodiment of the present invention;

FIG. 8A shows a transport stream (TS) recorded in a video tape in accordance with another embodiment of the present invention; and

FIG. 8B shows a transport stream (TS) recorded in a hard disk in accordance with another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The apparatus and method for searching an image of an image recording and reproducing device of the present invention is featured in that a randomly accessible large capacity memory is installed to reproduce and search an image signal recorded in a digital video tape at a high or low speed.

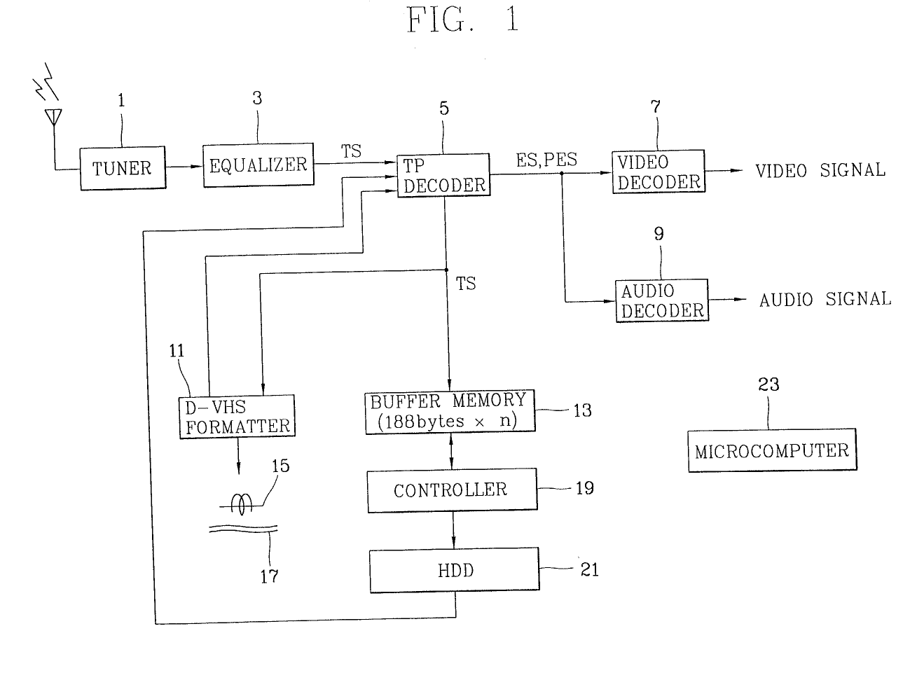

FIG. 1 is a schematic block diagram of an image searching apparatus of an image recording and reproducing device in accordance with one embodiment of the present invention.

As shown in the drawing, the image searching apparatus of an image recording and reproducing device of the present invention includes a tuner 1 for tuning a broadcast signal received from an antenna; an equalizer 3 for receiving the signal tuned by the tuner 1 and generating an input data stream of a channel selected by a user; a TP (transport) decoder 5 for receiving the input data stream, decoding it to an ES (Elementary Stream), a PES (Packetized Elementary Stream) or TS (Transport Stream) and outputting the same; a video decoder 7 and an audio decoder 9 for receiving the ES or the PES of a channel from the TP decoder 5 and outputting an image signal and an audio signal, respectively; a DVHS formatter 11 for receiving the TS from the TP decoder 5, processing it in a data form of a DVHS recording format, recording it in a DVHS video tape 17 through a video head 15, reproducing the data recorded in the DVHS video tape by means of the video head 15, converting it to a TS, outputting it to the TP decoder 5, and outputting absolute position information indicating an absolute position of a track on a video tape at which the TS is recorded, that is, the absolution position information of the track included in a sub-code area among the recording format of the DVHS, to a microcomputer 23, when the TS is recorded in the track of the video tape; a buffer memory 13 for receiving and storing the TS outputted from the TP decoder 5; a controller 19 for controlling to read the TS having an I picture from the TSs of the channel stored in the buffer memory 13, receive the recording position information of the tape from the microcomputer 23, record the TS having the I picture and the recording position information of the video tape in a hard disk 21, and read the TS having the I picture and the recording position information of the video tape stored in the hard disk 21 according to a search command key inputted by the user; and the microcomputer 23 for controlling the circuit units.

The buffer memory 13 has the same size as the PES which is formed including additional information by the TP decoder 5 upon receipt of the TS, and the number of buffer memories can be set arbitrarily by the user as many as desired.

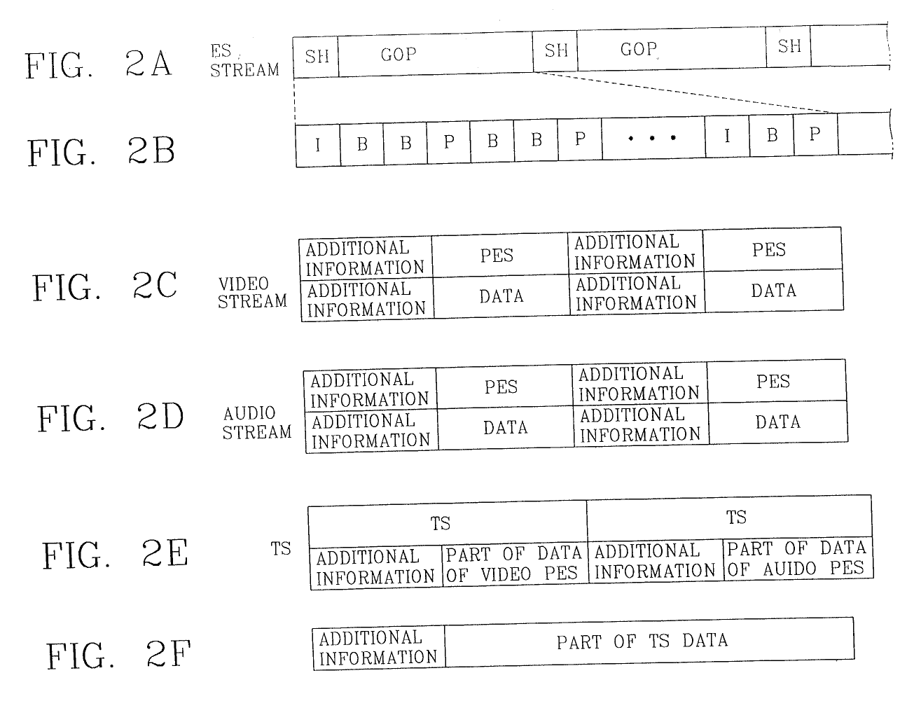

The signals processed by each circuit unit of the image searching apparatus of the image recording and reproducing device of the present invention constructed as described are MPEG signals, of which hierarchy structure is as shown in FIGS. 2A through 2F.

In detail, FIG. 2A shows an ES stream consisting of a sequence header and a GOP (Group of Picture).

FIG. 2B shows pictures included in the ES stream of FIG. 2A. One sequence header (SH) and one GOP includes a predetermined number of I, B and P pictures.

FIG. 2C shows a PES (Packetized Elementary Stream) of video pictures, which are formed by adding additional information to the predetermined number of I, B and P pictures.

FIG. 2D shows a PES of an audio signal, which is formed by adding a additional information to the audio signal corresponding to the video signal.

FIG. 2E shows TSs (Transport stream) of the PES of the video signal and the audio signal, each of which has a certain bytes (i.e., 188 bytes, etc) by adding additional information to the PES of the video signal and the audio signal.

FIG. 2F shows a data format recorded in a video tape, which is formed by adding additional information to a portion of the TS data of FIG. 2E.

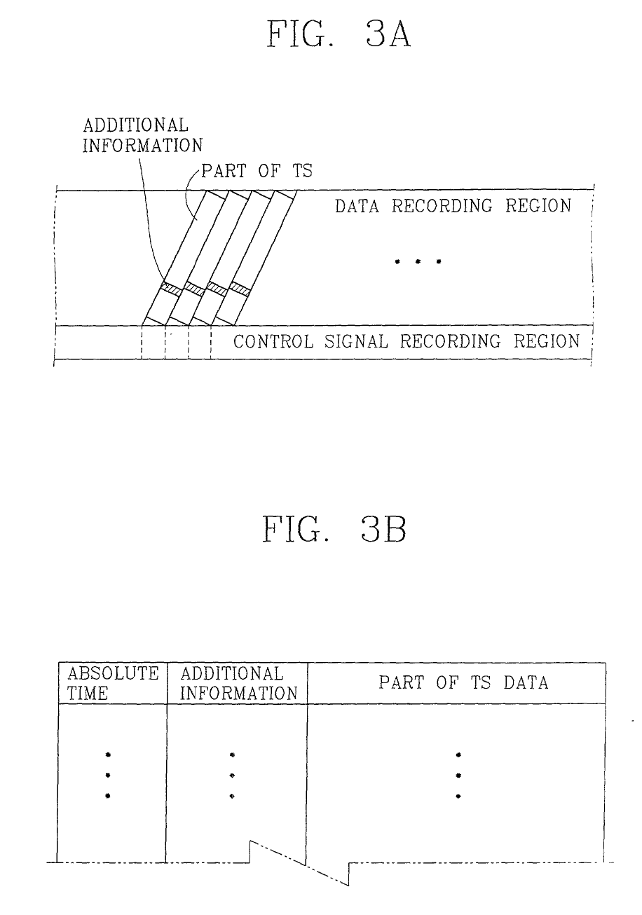

The operation of the image searching apparatus of the image recording and reproducing device constructed as described above will now be explained with reference to FIGS. 3 through 6.

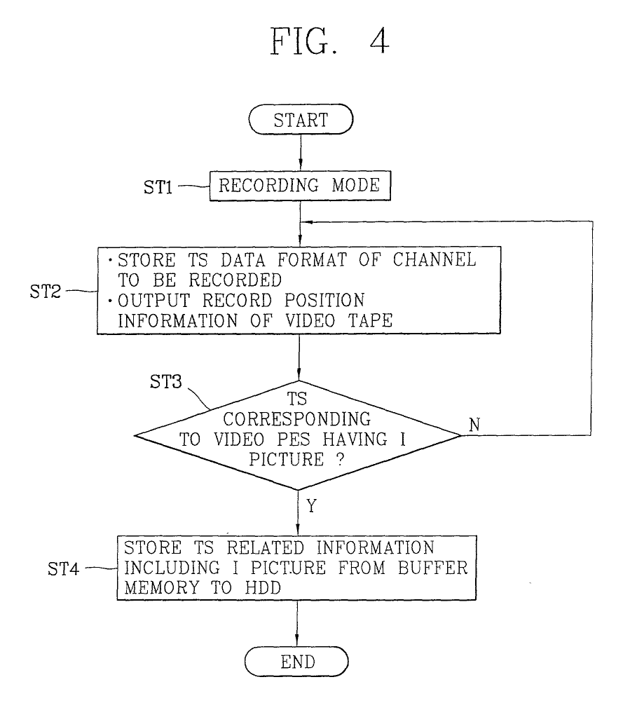

FIG. 4 is a flow chart of a method for recording an image of an image searching apparatus of an image recording and reproducing device in accordance with the present invention.

Mode for recording a signal (i.e., a broadcast signal, etc) received from an external signal source in a video tape (ST1)

When the tuner 1 tunes a broadcast signal as received through the antenna and outputs the tuned signal to the equalizer 2, the equalizer 2 corrects an error of the tuned signal, generates a TS (Transport Stream) and outputs the TS to the TP decoder 5.

Upon receipt of the TS, the TP decoder 5 outputs the ES or the PES as shown in FIGS. 2A and 2B to the video decoder 7 and the audio decoder 9.

Then, the video decoder 7 outputs image frames to the display unit (not shown), while the audio decoder 9 outputs a sound to the speaker (not shown).

Meanwhile, in case that the user outputs a command signal to record a TS corresponding to a specific channel among the TSs of several channels received by the antenna, to the microcomputer 23, the TP decoder 5 separates the TS of the channel to be recorded as shown in FIG. 2E from the inputted TS and outputs it to the DVHS formatter 11 and the buffer memory 13.

Then, the DVHS formatter 11 receives the TS of the channel to be recorded, forms a TS data format having recording position information of the tape as shown in FIG. 2F, and records it in the data record area of the video tape 17 as shown in FIG. 3A through the head 15.

The TS data format is recorded in the video tape, and at the same time, the recording position information of the tape is outputted to the microcomputer ST2.

Simultaneously, under the control of the microcomputer, the controller 19 judges whether there is a video PES corresponding to the I picture (refer to FIG. 2B) in the TS (refer to FIG. 2E) which is outputted from the TP decoder 5 in the buffer memory 13 (ST3).

Upon judgement, in case that there is a PES corresponding to the I picture in the TS, the controller 19 stores information on the TS having the I picture in the hard disk 21.

That is the controller 19 reads the TS including the I picture from the TS of the channel stored in the buffer memory 13, and at the same time, outputs it from the DVHS formatter 41 to the microcomputer 23, receives the recording position information of the video tape from the microcomputer 23, and stores the TS having the I picture as read from the buffer memory 13, the additional information of the TS and the recording position information of the tape outputted from the microcomputer 23, in the hard disk 21 (ST4).

The signal recorded in the video tape is the same as shown in FIG. 3A, and the data form stored in the hard disk is the same as shown in FIG. 3B.

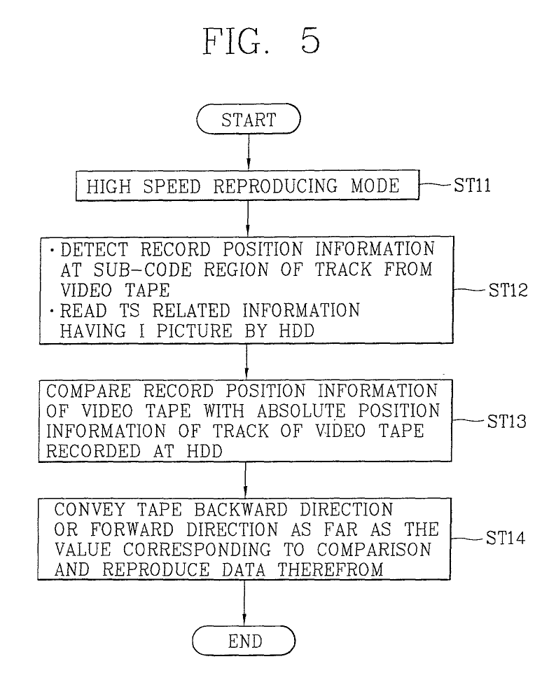

FIG. 5 is a flow chart of a high-speed searching method of an image searching apparatus of the image recording and reproducing device in accordance with the present invention.

In case that the user inputs a command key (Que) corresponding to the backward high speed reproducing or the forward high speed reproducing or a review to the microcomputer 23 while the image recording and reproducing device is operating in a reproducing mode, the microcomputer 23 controls the image recording and reproducing device to perform high speed reproducing operation (ST11).

In other words, when the user inputs a command for the backward high speed reproducing or the forward high speed reproducing, the controller 19 keeps detecting the recording position information in the sub-code area of the track on the video tape while performing the normal reproducing mode for a certain period after command for the backward high speed reproducing or the forward high speed reproducing is inputted, and outputs a TS related information including the I picture from an address of the hard disk at which the detected recording position information is identical to the recording position information previously stored in the video tape (S12).

Then, in order to output an image signal on the display unit through the video decoder 7, the TP decoder 5 receives the signal outputted from the hard disk 21, processes and outputs it to the video decoder 7 (ST7).

That is, the image recording and reproducing device is able to implement a searching mode by using the I picture outputted from the hard disk. And, when a reproduction command is inputted from the user during the backward high speed reproducing or the forward high speed reproducing, the image recording and reproducing device compares the recording position information of the video tape stored in the same address of the hard disk as that of the still image outputted from the hard disk and the absolute position information of a track of the video track (ST13), conveys the tape in the backward direction or in the forward direction at a high speed as far as the recording position information corresponding to the difference generated according to the comparison, and performs reproducing operation (ST14).

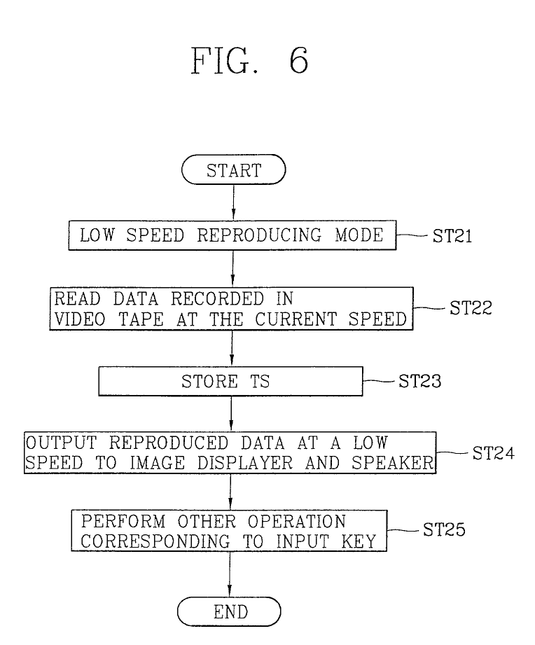

FIG. 6 is a flow chart of a low-speed searching method of an image searching apparatus of the image recording and reproducing device in accordance with the present invention.

When the user inputs a command key corresponding to the forward low-speed reproducing or the backward low-speed reproducing to the microcomputer 23 during the operation in the reproducing mode, the microcomputer 23 controls the image recording and reproducing device to perform a low-speed reproducing operation (ST21).

That is, during the reproducing operation, when a key requesting the low-speed reproducing operation is inputted from the user, the microcomputer 23 controls the head to read the data recorded in the video tape, while maintaining the current speed of the conveying speed and the reproducing speed of the video tape (ST22).

The data read from the head is converted into a reproduction signal by the DVHS formatter 11 and outputted to the TP decoder 5, and the TP decoder 5 outputs the TS to the hard disk 21.

The hard disk 21 stores the TS received from the TP decoder 5 under the control of the controller 19 (ST23).

Thereafter, the data outputted from the hard disk at a speed corresponding to the low-speed reproducing speed requested by the user is inputted to the TP decoder, and the TP decoder outputs the inputted signal to the video decoder and the audio decoder, so that the video decoder and the audio decoder outputs a video signal and a sound signal to the display and the speaker, respectively (S24).

When the low-speed reproducing operation desired by the user is completely performed, the low-speed reproducing operation is released, and then when a different key is inputted, a corresponding operation is performed (ST25).

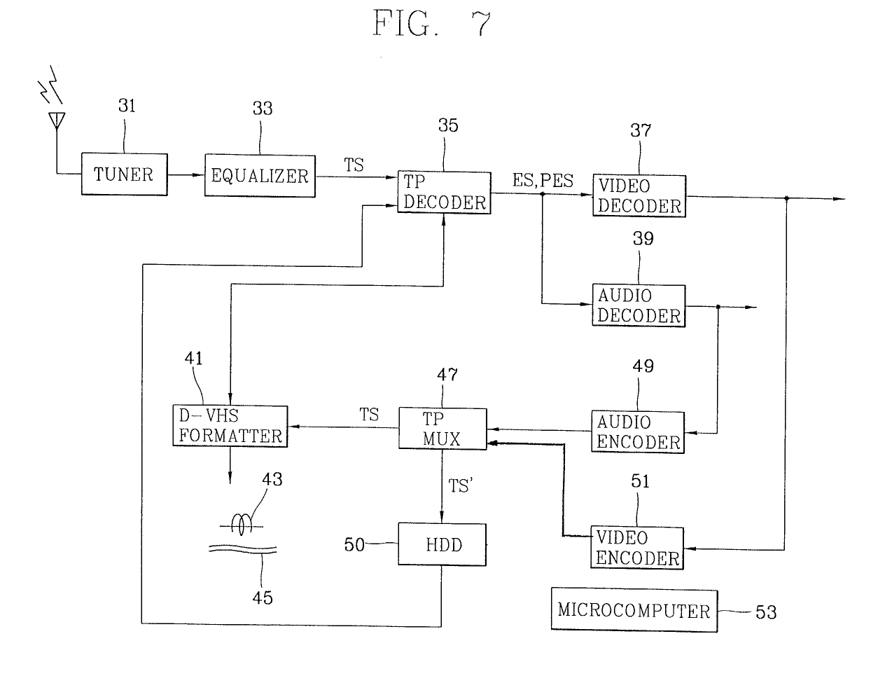

FIG. 7 is a schematic block diagram of an image searching apparatus of an image recording and reproducing device in accordance with another embodiment of the present invention.

As shown in the drawing, the image searching apparatus of an image recording and reproducing device in accordance with another embodiment of the present invention includes a tuner 31 for tuning a broadcast signal received through an antenna; an equalizer 33 for receiving the signal tuned by the tuner 31 and generating an input data stream of a channel selected by a user; a TP (transport) decoder 35 for receiving the input data stream, decoding it to a ES (Elementary Stream), a PES (Packetized Elementary Stream) or TS (Transport Stream) and outputting the same; a video decoder 37 for receiving the ES or the PES from the TP decoder 35, decoding and outputting to a display unit such as a DTV; an audio decoder 39 for receiving the ES or the PES from the TP decoder 35, decoding and outputting it to a speaker; a video encoder 51 for receiving an image signal from the video decoder 37 and outputting an ES-encoded or an PES-encoded image signal; an audio encoder 49 for receiving a sound signal outputted from the audio decoder 39 and outputting an ES-encoded or an PES-encoded sound signal; a TP multiplexer 47 for receiving the ES-encoded or the PES-encoded image signal or sound signal from the video encoder 51 and the audio encoder 49, encoding it to TSs, multiplexing them and generating a TS and a TS having an I picture; a DVHS formatter 41 for receiving the TS from the TP multiplexer 47, processing it in a pre-set standard, that is, for example, in a DVHS form, recording the processed DVHS data in the DVHS video tape 45 through a video head 43, outputting a record position signal of a track of the video track at which the TS is recorded, to the microcomputer, receiving the data recorded in the DVHS video tape through the video head 43, processing it to a reproduction signal, outputting the reproduction signal to the TP decoder 35, and outputting absolute position information of the track included in a sub-code area among the recording format of the DVHS to the microcomputer 53; a hard disk 50 for receiving and storing the TS having the I picture generated as the DVHS formatter 41 receives the record position signal of the track from the microcomputer 53 and the TS having the I picture from the TP multiplexer 47, and outputting the TSs to the TP decoder 35 under the control of the microcomputer; and the microcomputer 35 for I, controlling the circuit units.

The operation of the recording mode and the searching mode of the image searching apparatus of an image recording and reproducing device in accordance with the second embodiment of the present invention constructed as described above will now be explained.

1) The recording mode for recording a signal received from an external signal source in the video tape

In case that a user records a specific channel in the DVHS VCR, the received signal passes the antenna, the tuner 31 and the equalizer 33, so to be converted to a TS and outputted to the TP decoder 35. The TP decoder 35 decodes the TS and outputs the ES or the PES to the video decoder 37 and the audio decoder 39.

Then, the video decoder 37 and the audio decoder 39 decodes the ES or the PES received from the TP decoder and outputs an image signal and a sound signal to the image displayer and the speaker.

At the same time, the video encoder 51 and the audio encoder 49 receives the image signal and the sound signal from the video decoder 37 and the audio decoder 39, encodes them to ES or PES, and outputs them to the TP multiplexer 47, respectively.

The multiplexer 47 multiplexes and separates the ES or the PES received from the video encoder 51 and the audio encoder 49, generates a TS, and then generates the TS and a TS having the I picture.

Then, the DVHS formatter 41 receives the recording position information of a track from the microcomputer 53, stores the TS having the generated I picture and the recording position information of the track of the video tape outputted from the microcomputer 53, and outputs the generated TS to the DVHS formatter 41.

Accordingly, the signal received from the external signal source is stored in the video tape, and at the same time, the TS having the I picture is stored in the hard disk.

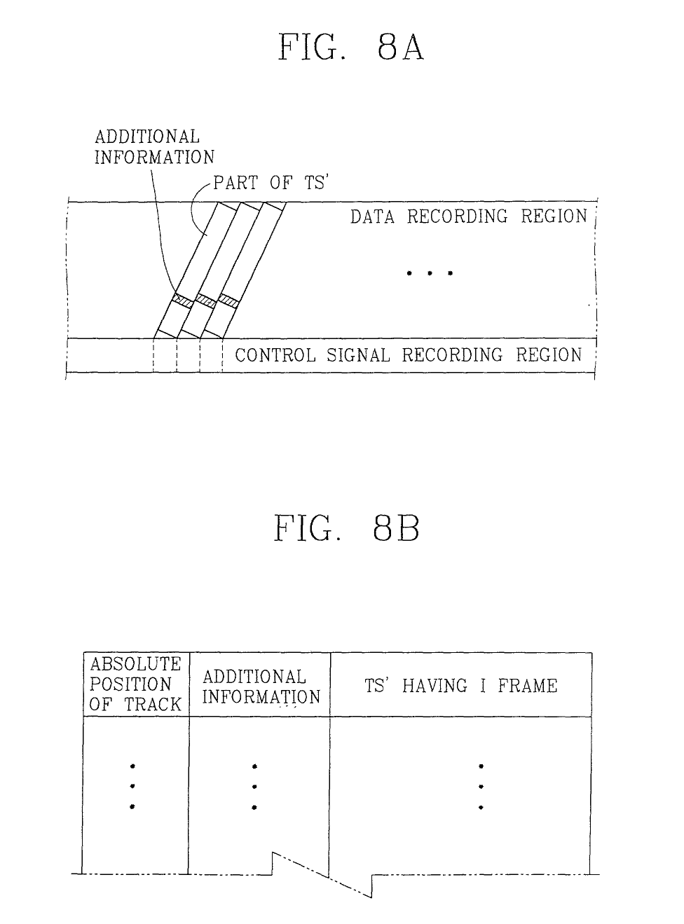

In this respect, the TS having the I picture as shown in FIG. 8A is stored in the data area of the video tape.

At the same time, the hard disk, as shown in FIG. 8B, stores the absolute position of the track where the TS has been recorded in the data area of the video tape, the additional information of the TS associated with the address of the hard disk and the TS in its address region.

Accordingly, in the image searching apparatus of an image recording and reproducing device in accordance with another embodiment of the present invention, when the signal received from an external signal source is recording in the video tape or the signal recorded in the video tape is reproduced, the information related to the TS desired by the user, that is, the stream having the I picture, is stored in the hard disk.

2) The operation of the image searching device of an image recording and reproducing device in accordance with another embodiment of the present invention in the high speed reproducing mode and in the low-speed mode is similar to that of the first embodiment.

As so far described, according to the apparatus and method for searching an image of an image recording and reproducing device of the present invention, the randomly accessible large capacity hard disk is installed and a simple servo controlling and signal processing algorithm is applied to control the hard disk, so that the image signal recorded in the video tape can be searched at a low or high speed simply and within a short time. Accordingly, the video head and the deck mechanism can be prevented from breaking down.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An apparatus for searching an image of an image recording and reproducing device in which input data streams received from various signal sources are processed and accordingly generated image and audio signals are outputted to an image displayer and a speaker, comprising:
a data stream selector for receiving the input data streams, selecting and outputting an input data stream of a channel selected by a user;
a decoding unit for decoding the data stream outputted from the data stream selector;
a formatter for receiving the data stream from the data stream selector, converting it to a record signal, outputting the record signal to a recording medium, detecting the signal recorded in the recording medium, generating a reproduction signal, and outputting the reproduction signal to the data stream selector;
a controller for judging whether there is a data stream having an I picture among the input data stream outputted from the data stream selector,
a memory associated with the selected input data stream recorded in the recording medium, for storing the data stream having I picture among the selected input data streams under the control of the controller; and
a microcomputer for controlling each circuit unit.

2. The apparatus according to claim 1, wherein the data stream selector comprising:
an antenna for receiving a ground wave broadcast signal;
an equalizer for tuning the broadcast signal received by the antenna; and
a decoding unit for decoding a data stream outputted from the equalizer.

3. The apparatus according to claim 1, wherein the decoding unit comprising:
a video decoder for receiving the frame data stream generated on the basis of the selected input data and outputting an image signal; and
an audio decoder for receiving the frame data stream generated on the basis of the selected input data and outputting a sound signal.

4. The apparatus according to claim 1, wherein the input data streams are various broadcast signals received from an external source or a reproduction signal outputted as the formatter reads a recorded signal from the recording medium.

5. The apparatus according to claim 1, wherein the memory comprising:
a buffer memory for storing a data stream having an I picture among the inputted data streams under the control of the controller; and
a hard disk for storing the data stream having the I picture in case that the data stream having the I picture buffered in the buffer memory is filled in the buffer memory of a pre-set size, and outputting the data stream having the stored I picture to the decoding unit under the control of the microcomputer.

6. The apparatus according to claim 5, wherein the buffer memory is of a size as large as the data stream having the I picture outputted from the decoding unit forms one I picture.

7. The apparatus according to claim 5, wherein a plurality of buffer memories are arranged.

8. The apparatus according to claim 5, wherein the hard disk stores an absolute time at which the selected input data stream is stored in the recording medium, a part of the data stream having the I picture and the additional information of the data stream having the I picture, in association with each other.

9. A method for searching an image of an image recording and reproducing device in which input data streams received from an image and sound signal sources are processed, comprising:
a first step in which an input data stream of a channel selected by a user among the input data streams is processed and recorded in a tape, and at the same time, a data stream having I picture among the input data streams of the channel selected by the user is stored in a large capacity memory;
a second step in which when the user inputs a backward high speed reproduction command or a forward high speed reproduction command, a still image outputted from the data stream having I picture stored in the memory; and
a third step in which when the user inputs a normal reproduction command during the operation in the backward high speed reproducing mode or the forward high speed reproducing mode, the reproducing operation is performed from a position of a tape at which the still image outputted from the memory has been recorded.

10. The method according to claim 9, wherein the input data stream are a broadcast signal received from an external source or a reproduction signal reproduced from the recording medium by the image recording and reproducing device.

11. The method according to claim 9, wherein, in the first step, the input data stream is stored associated with an absolute time stored in the recording medium, a part of the data stream having the I picture and the additional information of the data stream having the I picture.

12. A method for searching an image of an image recording and reproducing device in which input data streams received from an image and sound signal sources are processed, comprising:
a first step in which an input data stream of a channel selected by a user among the Input data streams is processed and recorded in a recording medium, and at the same time, a data stream having I picture among the input data streams of the channel selected by the user is stored in a large capacity memory;
a second step in which it is judged whether the image recording and reproducing device is in a low-speed reproducing mode;
a third step in which in case that the image recording and reproducing device is in a low-speed reproducing mode, the recording medium is normally reproduced and its outputted signal is stored in the memory; and
a fourth step in which the reproduction signal is read from the memory at a low speed and displayed.

13. An apparatus for searching an image of an image recording and reproducing device in which input data streams received from various signal sources are processed and accordingly generated image and audio signals are outputted to an image displayer such as a DTV and a speaker, comprising:
a data stream selector for receiving the input data stream and selecting an input data stream of a channel selected by a user;
a decoding unit for decoding the selected data stream and outputting an image signal and a sound signal;
a signal processor for receiving the image signal and the audio signal, encoding and multiplexing them, and outputting the multiplexed data stream and a data stream having an I picture in the multiplexed data stream;
a formatter for converting the data stream outputted from the signal processor into a record signal, outputting the record signal to a recording medium, detecting the signal recorded in the recording medium, generating a reproduction signal and outputting the reproduction signal to the decoding unit;
a memory for receiving the data stream having the I picture from the signal processor, storing the data stream having the I picture received from the signal processor associated with the data stream recorded in the recording medium, and outputting the stored data stream having the I picture to the decoding unit; and
a microcomputer for controlling circuit units.

14. The apparatus according to claim 13, wherein the data stream selector comprising:
an antenna for receiving a ground wave broadcast signal;
an equalizer for tuning the broadcast signal received by the antenna; and
a decoding unit for decoding a data stream outputted from the equalizer.

15. The apparatus according to claim 13, wherein the decoding unit comprising:
a transport (TP) decoder for decoding the selected input data stream and outputting frame data streams;
a video decoder for receiving the frame data streams from the TP decoder and outputting the image signal; and
an audio decoder for receiving the frame data streams from the TP decoder and outputting the sound signal.

16. The apparatus according to claim 13, wherein the signal processor comprising.
a video encoder for receiving and encoding the image signal and outputting the encoded image signal;
an audio encoder for receiving and encoding the sound signal and outputting the encoded sound signal; and
a transport (TP) multiplexer for receiving the encoded image signal and the encoded sound signal, outputting the data stream, and outputting a data stream having the I picture in the data stream.

17. The apparatus according to claim 13, wherein the input data streams are various broadcast signals received from an external source or a reproduction signal outputted as the formatter reads a recorded signal from the recording medium.

18. The apparatus according to claim 13, wherein the memory stores an absolute position of a track at which the data stream outputted from the signal processor is recorded in the recording medium, the data stream having the I picture and the additional information of the data stream having the I picture, in a manner of being related with each other.
